(19) United States
(12) Patent Application Publication
(10) Pub. No.: US 2007/0076158 A1
(43) Pub. Date: Apr. 5, 2007

(54) Liquid crystal display and method of manufacturing the same

(75) Inventors: Min-Sik Jung, Seoul (KR); Yun Jang, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/527,972

(22) Filed: Sep. 26, 2006

(30) Foreign Application Priority Data
Oct. 5, 2005 (KR) 2005-93565

(51) Int. Cl. G02F 1/1343

(52) U.S. Cl. 349/143

(57) ABSTRACT

A liquid crystal display device includes a substrate, liquid crystal disposed on the substrate, and a protrusion to influence on the alignment of the molecules of the liquid crystal to increase a viewing angle. The protrusion includes portions with different sizes, depending on the desired control power of the protrusion on the alignment of the molecules. That is, the portion size increases in the area where more control power is desired, and the portion size decreases in the area where less control power is desired. The protrusion is formed by depositing and pattering a thick photoresist. At the same time, a spacer can be formed.

### CROSS-REFERENCE TO RELATED APPLICATION

This application claims priority to Korean Patent Application No. 2005-0093565 filed on Oct. 5, 2005, the disclosure of which is hereby incorporated herein by reference in its entirety for all purposes.

### BACKGROUND

1. Field of the Invention

The present invention relates generally to liquid crystal displays (LCDs) and methods of manufacturing the same.

2. Description of Related Art

A liquid crystal display (LCD) is widely used in flat panel displays. An LCD includes two panels or substrates with field-generating electrodes (i.e., a pixel electrode and a common electrode) and a liquid crystal (LC) layer interposed therebetween. The LCD displays images by applying voltages to the electrodes to generate an electric field in the LC layer, which determines orientations of LC molecules in the LC layer to adjust polarization of incident light and brightness of the LCD.

The LC has a dielectric anisotropy and a refractive anisotropy. The dielectric anisotropy causes the electric field in the LC layer to control orientations of LC molecules, and the refractive anisotropy causes phase retardation of incident light to adjust brightness of the LCD.

One disadvantage of a conventional LCD is that it has a narrow viewing angle. Various techniques for expanding the viewing angle have been suggested. One such technique utilizes a vertically aligned LC with cutouts or protrusions at the field-generating electrodes, such as pixel electrodes and a common electrode. The protrusions or the cutouts distort the primary electric field and enables the pixel to be divided into multiple regions or domains so that each region can have a different tilt direction of the LC molecules. However, boundary conditions at the edge of a pixel prevents the molecules of the LC at the pixel edge from being tilted as desired, thereby reducing operation characteristics such as brightness and light transmittance.

Accordingly, there is need for an LCD device without the disadvantages of conventional LCDs discussed above.

### SUMMARY

The present invention provides a LCD device and a method for manufacturing the same, which may increase brightness and light transmittance of the LCD device. In an exemplary LCD device according to the present invention, the LCD device includes a plurality of pixels to display images, a transparent conductor formed on each pixel, a protrusion disposed over the transparent conductor and having different sizes depending on where it is located on the pixel, and a liquid crystal layer aligned in the pixel.

In one embodiment, the protrusion includes a first portion connected to a second portion having a smaller size than the first portion. The first portion is inclined against the edge of the pixel, and the second portion is parallel to the edge of the pixel. The LCD device may further include a third portion located in the middle of the first portion and having smaller size than the first portion. The third portion can be bigger than or equal to the second portion.

In another exemplary LCD device according to the invention, the LCD display device includes a first substrate and a second substrate facing with the first substrate, a liquid crystal layer interposed between the first substrate and the second substrate, a gate line and a data line formed on the first substrate and crossing each other to define a pixel, a pixel electrode having a cutout portion and formed on each pixel, a common electrode formed on the second substrate and facing the pixel electrode; and a protrusion formed on the pixel and having different sizes on different areas of the pixel.

The cutouts and the protrusion are spaced apart from each other and interact to allow formation of multiple regions or domains. In another embodiment, a spacer formed of the same material as and higher than the protrusion is interposed between the first substrate and the second substrate. The spacer and the protrusion may be formed at the same time by patterning the same photoresist film. Because the spacer is formed at a height greater than the protrusion, the photoresist film is formed with a greater thickness than the height of the protrusion. This enables easier control of the removal of the photoresist film for forming protrusions of different sizes. The protrusion includes a first portion inclined against the gate line or the data line and a second portion parallel to the gate line or the data line having a smaller size than the first portion.

A method for manufacturing a LCD in accordance with one embodiment of the present invention includes forming a gate line and a data line across the gate line to define a pixel on a first substrate, forming a pixel electrode with a cutout on the pixel, forming a common electrode on a second substrate facing the pixel electrode, forming a protrusion on the area of the common electrode corresponding to the pixel, where the size of the protrusion is different on different areas of the pixel; and assembling the first substrate and the second substrate.

A better understanding of the above and many other features and advantages of the improved LCDs of the present invention may be obtained from a consideration of the detailed description of the exemplary embodiments thereof below, particularly if such consideration is made in conjunction with the several views of the appended drawings, wherein like reference numerals are used to identify like elements illustrated in one or more of the figures thereof.

### BRIEF DESCRIPTION OF THE DRAWINGS

The features of the present invention will become more apparent to those of ordinary skill in the art by describing in detail exemplary embodiments thereof with reference to the attached drawings, in which:

FIG. 1 is a schematic plan view of a substrate of an LCD device according to an embodiment of the present invention;

FIGS. 2A and 2B are graphs illustrating brightness and contrast ratio, respectively, in black grey as a function of protrusion height;

FIGS. 3A and 3B are graphs of light transmittance efficiency as a function of gray scale for various protrusion widths;

FIG. 4 is a microphotograph of pixels with various protrusion widths;

FIG. 5A is a plan view of an LCD device according to an embodiment of the present invention;

FIG. 5B is a cross-sectional view taken along the line I-I′ of FIG. 5A; and

FIGS. 6 to 12 are cross-sectional views showing various process steps for forming the LCD device of FIGS. 5A and 5B according to an embodiment of the present invention.

### DETAILED DESCRIPTION

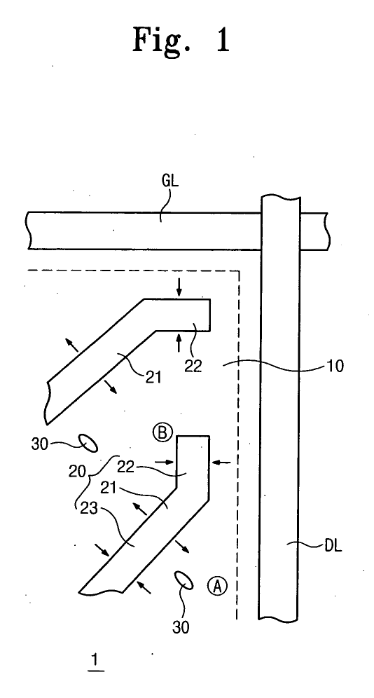

FIG. 1 is a schematic plan view of a substrate of an LCD device according to an embodiment of the present invention. A substrate 1 includes a transparent electrode 10, a protrusion 20 protruding upward, and a liquid crystal (LC) 30 disposed over substrate 1. One or more protrusions 20 are formed on transparent electrode 10, and the molecules of LC 30 are aligned at a tilt angle by applying voltage. The LCD device includes an upper and a lower substrate. Substrate 1 can be either. If substrate 10 is a lower substrate, transparent electrode 10 is a pixel electrode and the lower substrate includes a gate line GL and a crossing data line DL defining a pixel (dotted line). If substrate 10 is an upper substrate, transparent electrode 10 is a common electrode forming on the whole substrate with no separation between pixel regions.

Generally, protrusion 20 is formed on the upper substrate by patterning a photoresist, as will be described in detail below, because of manufacturing convenience. That is, the lower substrate includes cutouts which have same function as the protrusions and can be formed on the pixel electrode without an extra process at the same time pixel electrodes are formed. Thus, it is advantageous to form the cutouts instead of the protrusions on the lower substrate. Consequently, the protrusion should be formed on the upper substrate.

The molecules of LC 30 are tilted based on an electric field generated by applying a voltage difference between the transparent electrodes of the upper and lower substrates. Protrusions 20 distort or change the primary electric field, resulting in molecules that are tilted in symmetrical directions against protrusions 20.

Conventionally, the protrusions have identical size irrespective of location in a pixel, but according to one aspect of the present invention, protrusions 20 have different sizes depending on their location. “Size” of the protrusion means the volume of the protrusion which is determined by the area and the height of the protrusion.

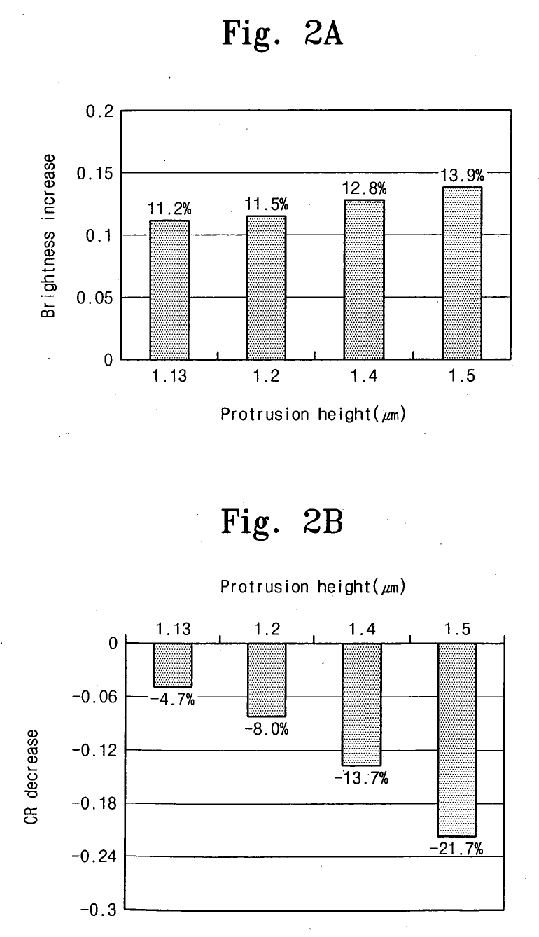

FIGS. 2A and 2B are graphs illustrating the brightness and contrast ratio, respectively, of an LCD device in black grey as a function of the protrusion height, where the width of the protrusions are constant.

Referring to FIG. 2A, brightness in black gray increases as protrusion height increases. When there is no electric field, the molecules of the LC align vertically to the surface of the substrate to display black as no light passes. When an electric field is generated, the molecules are tilted horizontally, thereby increasing light transmittance. As the tilt direction of the molecules approximates to a horizontal direction, the display color approximates to white. In principle, brightness of black is “0”. However, when protrusions are used, there is light leakage because some of the molecules of the LC are tilted in a non-vertical direction along the surface of the protrusions. As the protrusion height increases, light leakage increases, as shown in FIG. 2A. That is, the molecules of the LC are tilted in more horizontal direction as the protrusion height increases.

Comparing FIG. 2B to FIG. 2A, the contrast ratio (CR, i.e. brightness or light transmission ratio of a white state to a black state) decreases as brightness of black increases. As shown in FIG. 2B, the contrast ratio decreases about 5 times as the protrusion height increases from 1.13 μm to 1.5 μm.

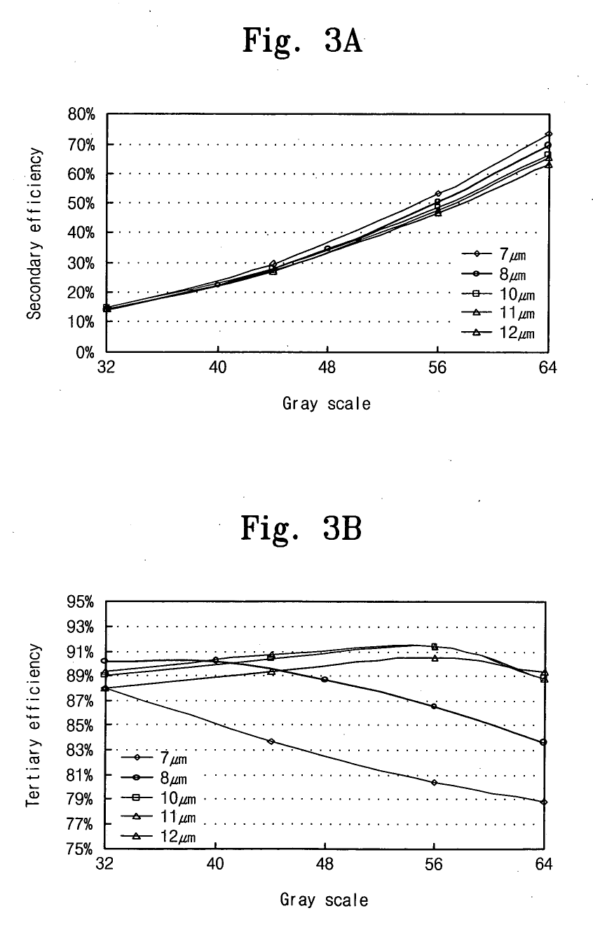

FIGS. 3A and 3B are graphs of light transmittance efficiency as a function of gray scale for various protrusion widths. FIGS. 3A and 3B show secondary efficiency and tertiary efficiency, respectively. Various factors influence light transmittance. “First efficiency” refers to transmittance by a structural factor such as an active display area or aperture ratio, “secondary efficiency” by the voltage level applied to the LC, and “tertiary efficiency” by an alignment uniformity of the molecules of the LC. The numerical values on FIGS. 3A and 3B represents widths of mask patterns for forming protrusions, not the actual protrusion width. The difference between the mask pattern width and the protrusion width is about 2 μm, and the protrusion width become larger as the mask pattern width increases.

Referring to FIGS. 3A and 3B, the secondary efficiency increases as the protrusion width decreases, whereas, the tertiary efficiency increases in proportion to the protrusion width. These results can be explained as follows.

The protrusions are formed of an insulating material on the transparent electrode, thereby blocking and reducing electric field in the LC layer in an area where the protrusions are disposed. Thus, an increase of the protrusion size causes the electric field to decrease. Accordingly, the secondary efficiency increases as the protrusion width decreases.

The tertiary efficiency is determined by a “texture” effect. The “texture” represents an area where the LC is not controlled sufficiently by the protrusion. For example, in an area where the protrusion is located, the molecules of the LC align irregularly with other areas, resulting in the area displaying darker than other areas in spite of being in the white state. However, if the protrusion width increases, the protrusion will act on more areas of the LC to better control the alignment and decreases irregular alignment. Accordingly, as the protrusion width increases as shown in FIG. 3B, the texture decreases and the tertiary efficiency increases. That is, control power of the protrusion to the LC increases as the protrusion size increases.

Thus, as seen from FIGS. 2A to 3B, the protrusion size, i.e., height and width, provides either an advantage or a disadvantage on an operation of the LCD device depending on location of the protrusion. Therefore, the present invention provides protrusions having a different size in different locations of a pixel.

Referring to FIG. 1, protrusion 20 includes a first portion 21 inclined at an angle against the gate line GL or the data line DL, and a second portion 22 parallel with the gate line GL or the data line DL. As arrows of FIG. 1 show, as the size of first portion 21 increases, the size of second portion 22 decreases. In one embodiment, first portion 21 has the same width as, but a higher height than second portion 22. In another embodiment, first portion 21 also has a wider width than second portion 22. Size difference between first portion 21 and second portion 22 is determined by design rules, such as a pixel size or a display resolution. When the size difference between the first and second portions is big, light leakage can increase due to a sharply inclined surface. Therefore, when there is a large size difference between the first and second portions, the ratio of width to height of first portion 21 and second portion 22 should be maintained approximately constant to prevent excessive light leakage.

At a pixel edge, the electric field in the LC layer is generated differently than from the inside of the pixel because each pixel is separated by and adjacent to the gate line GL and the data line DL. These lines carry an electric signal such as a gate-on voltage and a data voltage, thereby aligning the molecules of the LC irregularly. To reduce this problem and achieve uniform alignment inside the pixel and at the boundary, the control power of the protrusion on the LC should be increased. Accordingly, increasing the size of first protrusion 21 at the pixel edge enhances the control power on the LC to align the molecules regularly.

Second portion 22 connects one end of first portion 21 and is parallel with the gate line GL or the data line DL. Second portion 22 influences the LC in a different direction than first portion 21 to suppress the LC from being irregularly arranged at the boundary of the pixel. If the size of second portion 22 is bigger than first portion 21, the molecules adjacent to second portion 22 can align differently than molecules inside the pixel. Thus, the size of second portion 22 is smaller than first portion 21.

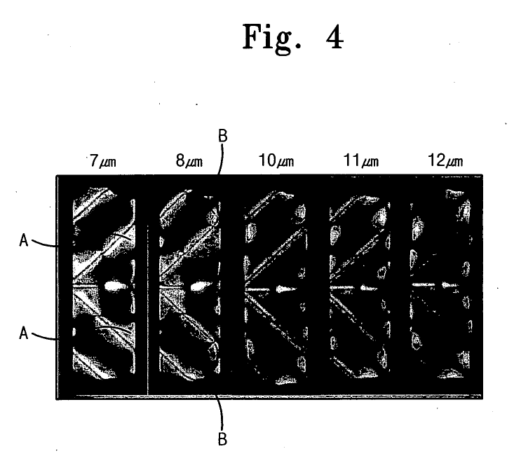

FIG. 4 shows micro photos of a pixel having various protrusion widths. The width numeric value represents a width of the mask pattern used to form the protrusions, as in FIGS. 3A and 3B.

As seen in FIG. 4, as the protrusion width increases, area “A” gets darker and area “B” gets brighter. Areas “A” and “B” of FIG. 4 corresponds to areas A and B of FIG. 1, respectively. The micro photos were taken of the pixel in white state after transmissive axes of two polarizers attached to the substrate changed from 0° to 45° and from 90° to 135°, respectively. In white state, it is difficult to determine whether the molecules of the LC align irregularly or not. However, when the transmissive axes change to 90° and 145°, the white changes to a black state even though the alignment of the molecules are kept constant, thereby showing areas having irregular alignment of the molecules as being brighter.

As shown in FIG. 4, area “A” becomes darker as the protrusion width increases. That means the alignment of the molecules in area “A” becomes more uniform as the protrusion width increases. Accordingly, it is desirable to make size of the protrusion influencing area “A”, i.e. first portion 21, bigger. Area “B” becomes brighter as the protrusion width increases, which means that the alignment of the molecules in area “B” become less uniform as the protrusion width increases. Accordingly, it is desirable to make the size of the protrusion influencing area “B”, i.e. second portion 22, smaller.

Referring to FIG. 1, first portion 21 may further include a third portion 23 in the area which is inclined against the pixel edge (i.e. the gate line GL or the data line DL). Because the control power of the protrusion on the LC is required to be enhanced adjacent to the pixel edge, there is no need for increasing the protrusion adjacent to the center part of the pixel. Therefore, third portion 23 should have a smaller size than first portion 21 to minimize light leakage due to a large protrusion.

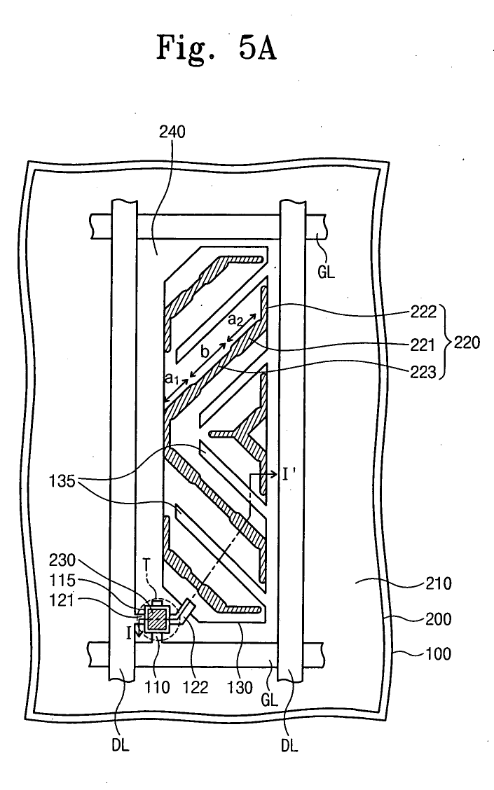

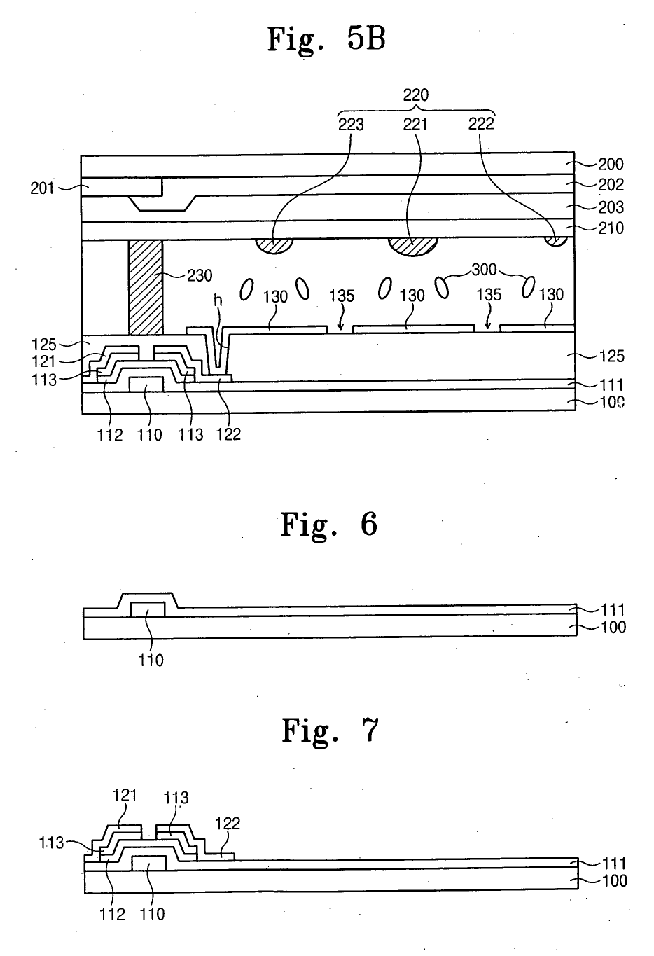

FIG. 5A is a plan view of an LCD device according to one embodiment of the present invention, and FIG. 5B is a cross sectional view taken along the line I-I′ of FIG. 5A.

The LCD device includes a lower substrate 100 (i.e. first substrate), an upper substrate 200 (i.e. second substrate), and a liquid crystal 300 interposed therebetween.

Gate lines GL and data lines DL are formed on first substrate 100. Gate lines GL carry gate signals and extend substantial parallel to one another in a horizontal direction. Data lines DL carry data signals and extend substantial parallel to one another in a vertical direction. Agate electrode 110 extends from gate line GL, and a source electrode 121 extends from data line DL. A drain electrode 122 is separated from source electrode 121. A pixel 240 is defined by gate lines GL and data lines DL and includes a thin film transistor T and a pixel electrode 130. Gate electrode 110, source electrode 121, and drain electrode 122 form thin film transistor T. Source electrode 121 and drain electrode 122 are insulted from gate electrode 110 by a gate insulating layer 111 and from pixel electrode by a passivation layer 125. Passivation layer 125 has a contact hole to connect drain electrode 122 to pixel electrode 130 having cutouts 135.

A black matrix 201 to prevent light leakage and color filters 202 to represent red, blue and green are formed on second substrate 200. An overcoat 203 is formed on black matrix 201 and color filters 202 to flatten an upper surface of second substrate 200. A common electrode 210 is formed on overcoat 203 facing pixel electrode 130. Protrusions 220 are formed on common electrode 210, and disposed alternately with cutouts 135 of pixel electrode 130 without overlapping cutouts 135. Protrusions 220 and cutouts 135 change the primary electric field in the LC layer, thereby tilting the molecules of the LC in different directions to form multi-domains for each pixel. These multi-domains increase a viewing angle of the LCD device. Spacers 230 are formed on common electrode 210 to keep a constant gap between first substrate 100 and second substrate 200 and in areas corresponding to black matrix 201 so that the aperture ratio is not reduced.

Protrusions 220 includes a first portion 221 inclined against the edges of pixel 240 (i.e. gate lines GL or data lines DL) at both ends of the inclined portion, a second portion 222 disposed in the end of first portion 221 and parallel with the edges of pixel 240, and a third portion 223 disposed between first portions 221. First portion 221 has a larger size than second portion 222 and third portion 223 to enhance the control power at the boundary portion of the pixel. Second portion 222 has a smaller size than first portion 221 to reduce a texture effect. Third portion 223 has the same or larger size than second portion 222 to reduce unnecessary light leakage generated due to the increase of the protrusion size. The length, height, and width of the protrusions can be adjusted depending on various factors, such as those influencing on the alignment of the molecules of the LC or the size of the display device. In one embodiment, the length a1 and a2 of first portion 221 is the same as the length b of third protrusion 223 (see FIG. 5A). In another embodiment, the length a1 and a2 can be half of the length b.

The pattern of protrusions 220 and cutouts 135 can also be adjusted. The protrusion size increases in areas where the control power of the protrusion on the LC is required to increase, and the size decreases in areas of reduced control power. Accordingly, protrusion 220 is not limited to three portions (i.e. first portion 221, second portion 222, and third portion 223). Protrusion 220 may include additional portions with different size depending on various factors influencing the alignment of the molecules of the LC.

Hereinafter, a method for manufacturing a display panel according to an embodiment of the present invention will be described in detail by referring to FIGS. 6 to 12.

Referring to FIG. 6, a gate electrode 110 and a gate insulating layer 111 are formed on a first substrate 100. Gate electrode 110 is formed by depositing, such as sputtering, and patterning a metal such as chromium, aluminum, or aluminum alloy. Gate insulating layer 111 is formed of silicon nitride using a plasma enhanced chemical vapor deposition to insulate gate electrode 110.

Referring to FIG. 7, a semiconductor pattern including an active pattern 112 and an ohmic contact 113 is formed on gate insulating layer 111. Active pattern 112 and ohmic contact 113 are formed in the area corresponding to gate electrode 110 by depositing amorphous silicon and n+ amorphous silicon doped with negative ion such as phosphorous, respectively. A source electrode 121 and a drain electrode 122 are formed on the semiconductor pattern.

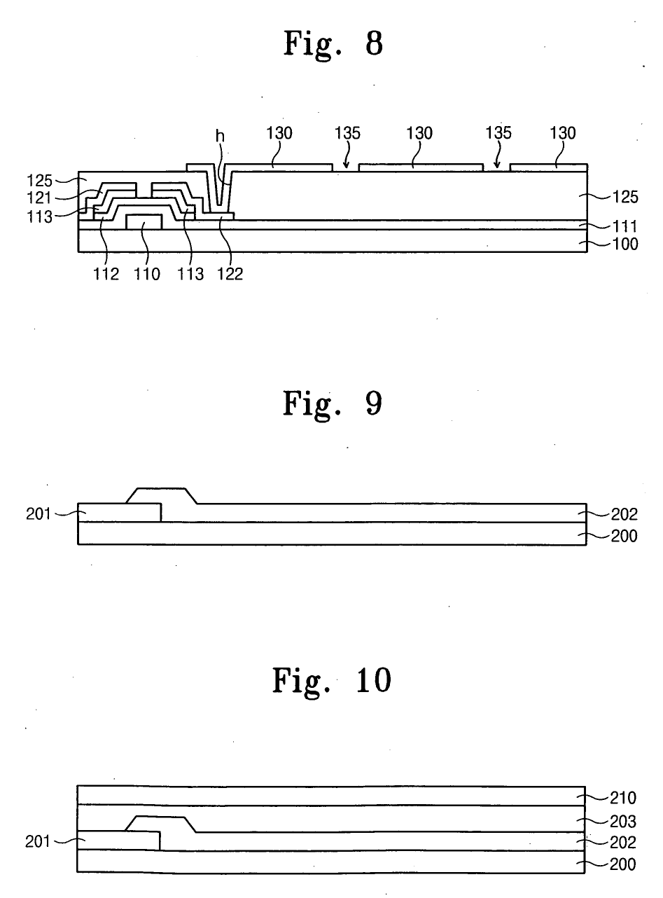

Referring to FIG. 8, a passivation layer 125 is formed over first substrate 100. Passivation layer 125 has a contact hole h to expose a portion of drain electrode 122. A pixel electrode 130 is formed on passivation layer 125 and in contact hole h. Pixel electrode 130 is formed of a transparent conductor such as indium tin oxide or indium zinc oxide. Pixel electrode 130 is separated from neighboring pixel electrodes, with cutouts 135 formed in each pixel region.

Referring to FIG. 9, a black matrix 201 or light shielding pattern and color filters 202 are formed on a second substrate 200. Black matrix 201 is formed by depositing and pattering a metal layer such as chromium or a carbon-based organic material. Color filters 202 are formed on black matrix in the area corresponding to the pixel by a photolithography of a color photoresist. Color filters 202 can represent at least one the primary colors, such as red, green, or blue.

Referring to FIG. 10, an overcoat 203 and a common electrode 210 are formed on color filter 202. Overcoat 203 planarizes an upper surface of second substrate 200 and to protect color filters 202 from subsequent processes. For example, overcoat 203 prevents an etching solution used in a subsequent process from damaging color filters 202. Common electrode 210 is formed, such as by deposition, of a transparent conductor such as indium tin oxide or indium zinc oxide.

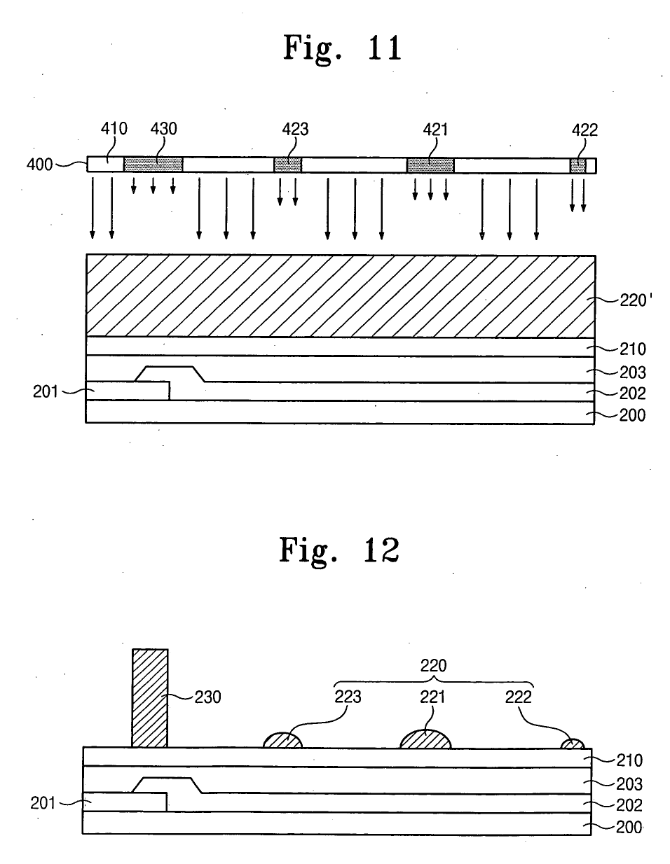

Referring to FIG. 11, a positive type photoresist 220′ is deposited on common electrode 210 and is exposed to light through a photomask 400. Photoresist 220′ is used to form the protrusion and has thickness as at least twice that of a desired protrusion height. If the thickness of photoresist 220′ is similar to the protrusion height, it is hard to form the protrusion having portions with different sizes. For example, if the width and the height of the first portion, the second portion, and the third portion shown in FIG. 5 is 14 μm, 1.3 μm/10 μm, 1 μm/9 μm, 0.9 μm respectively, and the thickness of the photoresist is 1.5 μm, the thickness to be removed from the photoresist to form the protrusion is about 0.2 μm to about 0.6 μm. Accordingly, it is difficult to form the protrusion having portions with the desired different heights.

Photomask 400 has transparent areas 410 and opaque areas 430, 422, 421, and 423 with different widths corresponding to the spacer, the first portion, the second portion, and the third portion of the protrusion, respectively, as shown in FIG. 5. The width of opaque areas is adjusted depending on the width of the protrusion. If there are more portions with different sizes, the photo mask 400 can have more opaque areas corresponding to the additional portions. The width of opaque areas limits the amount of light exposing photoresist 220′ to form desired sizes of the spacer and the portions of the protrusion. That is, as the width of opaque areas decreases, the corresponding area of the photoresist 220′ also decreases. In other embodiments, a slit pattern or a half-tone mask can be alternately used to control light amount at each region.

Referring to FIG. 12, a spacer 230 and protrusions 220 including a first portion 221, a second portion 222, and a third portion 223 are formed by exposing the photoresist to light through the mask and developing (i.e. photolithography). The width of the opaque areas determines the size of spacer 230 and protrusions 220. In one embodiment, the order of formation is spacer 230, first portion 221, third portion 223, and second portion 222.

The LCD device is completed by subsequent processes such as assembling the first substrate and the second substrate without superposing the protrusions on the cutouts, and injecting and enclosing the LC therebetween.

Accordingly, the embodiments of the present invention provide protrusions with different sizes depending on the area within a pixel, thereby controlling the alignment of the molecules of the LC and improving brightness and contrast ratio. Also, the spacer and the protrusions are formed at the same time by using the photoresist, thereby reducing cost and time for manufacturing. As those of skill in this art will appreciate, many modifications, substitutions and variations can be made in the materials, apparatus, configurations, and methods of the present invention without departing from its spirit and scope. In light of this, the scope of the present invention should not be limited to that of the particular embodiments illustrated and described herein, as they are only exemplary in nature, but instead, should be fully commensurate with that of the claims appended hereafter.

What is claimed is:

1. A liquid crystal display device comprising:
a plurality of pixels to display image;
a transparent conductor formed in each pixel;
a protrusion disposed over the transparent conductor and having different sizes depending on the area of the pixel the protrusion is located; and
a liquid crystal layer aligned in the pixel.

2. The liquid crystal display device of claim 1, wherein the protrusion comprises a first portion and a second portion having a smaller size than the first portion.

3. The liquid crystal display device of claim 2, wherein the first portion is inclined against an edge of the pixel.

4. The liquid crystal display device of claim 3, wherein the second portion connects to the first portion and is parallel to an edge of the pixel.

5. The liquid crystal display device of claim 4, further comprising a third portion located in the middle of the first portion and having smaller size than the first portion.

6. The liquid crystal display device of claim 5, wherein the third portion has a size larger than or equal to the second portion.

7. A liquid crystal display device, comprising:
a first substrate;
a second substrate facing with the first substrate;
a liquid crystal layer interposed between the first substrate and the second substrate;
a gate line;
a data line crossing the gate line to define a pixel to display images;
a pixel electrode having cutouts and formed in each pixel;
a common electrode formed on the second substrate and facing the pixel electrode; and
a protrusion formed in the pixel, wherein the protrusion has different sizes depending on the location of the protrusion in the pixel.

8. The liquid crystal display device of claim 7, wherein the cutouts and the protrusion are alternately disposed.

9. The liquid crystal display device of claim 8, further comprising a spacer interposed between the first substrate and the second substrate, wherein the spacer is formed of the same material as the protrusion.

10. The liquid crystal display device of claim 9, wherein the protrusion includes a first portion inclined against the gate line or the data line and a second portion connected to the first portion, parallel to the gate line or the data line, and smaller in size than the first portion.

11. The liquid crystal display device of claim 10, further comprising a third portion formed at a center portion of the first portion and having a smaller size than the first portion.

12. The liquid crystal display device of claim 11, wherein the third portion has a size larger than or equal to the second portion.

13. A method for manufacturing a liquid crystal display device comprising:
forming a gate line and a data line across the gate line to define a pixel on a first substrate;
forming a pixel electrode in the pixel, wherein the pixel electrode has cutouts;
forming a common electrode on a second substrate, wherein the common electrode faces the pixel electrode;
forming a protrusion on an area of the common electrode, wherein the size of the protrusion depends on the location of the protrusion on the pixel; and
assembling the first substrate and the second substrate.

14. The method of claim 13, wherein the cutouts and the protrusion are alternately disposed.

15. The method of claim 14, further comprising:
forming a spacer on the second substrate and interposed between the first substrate and the second substrate, wherein the spacer is formed at the same time the protrusion is formed.

16. The method of claim 15, wherein the protrusion comprises:
a first portion inclined against the gate line or the data line, and
a second portion connected to the first portion, wherein the second portion is parallel to the gate line or the data line and has a smaller size than the first portion.

17. The method of claim 16, wherein the protrusion further comprises a third portion disposed in a middle area of the first portion and having a smaller size than the first portion.

18. The method of claim 17, wherein the third portion has a size larger than or equal to the second portion.

19. The method of claim 18, wherein forming the protrusion and the spacer comprises;
depositing a photoresist on the common electrode; and
exposing the photoresist to light with a photo mask,
wherein the photo mask transmits a different amount of light to the area of the photoresist corresponding to the area where the spacer, the first portion, the second portion, and the third portion are formed, respectively.
